(19) United States
(12) Patent Application Publication
(10) Pub. No.: US 2026/0279200 A1
(43) Pub. Date: Sep. 17, 2026

(54) EXTERNAL REQUEST RESPONSE SYSTEM FOR COMMUNICATION OF PARKED VEHICLES

(71) Applicant: GM GLOBAL TECHNOLOGY OPERATIONS LLC, Detroit, MI (US)

(72) Inventors: Jeehyung Lee, Seoul (KR); Seokju Yong, Bucheon-si (KR); Beom Lee, Yeonsu-gu (KR); Woosuk Jang, Seoul (KR); Gaurav Talwar, Novi, MI (US)

(73) Assignee: GM GLOBAL TECHNOLOGY OPERATIONS LLC, Detroit, MI (US)

(21) Appl. No.: 19/080,745

(22) Filed: Mar. 14, 2025

(51) Int. Cl. G08G 1/0968; H04L 12/18; H04L 51/02

(52) U.S. Cl. CPC G08G 1/096883; H04L 12/1818; H04L 51/02

(57) ABSTRACT

In exemplary embodiments, methods and systems are provided that includes a processor of a vehicle and one or more sensors of the vehicle. The processor is configured to at least facilitate providing instructions for a notification proximate a vehicle that is parked, the notification including an instruction for an external actor to take an action in order to initiate communications with an owner of the vehicle. The one or more sensors of the vehicle that are configured to obtain sensor data detecting when the action has been taken. The processor is further configured to facilitate the communications between the owner of the vehicle and the external actor upon detection of the action taken by the external actor, via a virtual chatbot via a remote server that protects contact information of the owner of the vehicle, in accordance with instructions provided by the processor.

### TECHNICAL FIELD

The technical field generally relates to vehicles, and more particularly for communications between an external actor and an owner of a parked vehicle.

### BACKGROUND

In certain situations it may be desirable for an external actor to contact an owner of a parked vehicle. For example, in certain situations the external actor may request for the owner to move the vehicle, and/or may inform the owner as to an occurrence or event pertaining to the vehicle.

Accordingly, it is desirable to provide improved methods and systems for facilitating communications between an external actor and an owner of a parked vehicle.

### SUMMARY

In accordance with an exemplary embodiment, a method is provided that includes providing, via instructions provided by a processor, a notification proximate a vehicle that is parked, the notification including an instruction for an external actor to take an action in order to initiate communications with an owner of the vehicle; detecting, via one or more sensors of the vehicle, when the action has been taken via sensor data obtained via the one or more sensors; and facilitating the communications between the owner of the vehicle and the external actor upon detection of the action taken by the external actor, via a virtual chatbot via a remote server that protects contact information of the owner of the vehicle, in accordance with instructions provided by the processor.

Also in an exemplary embodiment, the action includes a knocking of a windshield of the vehicle by the external actor; the notification includes the instruction for the external actor to knock on the windshield to initiate the communications with the owner of the vehicle; and the action is detected based on microphone data obtained via a plurality of microphones of the vehicle, and via a comparison via the processor of the microphone data with one or more known sound signatures that are stored in memory and that correspond to knocking of the windshield.

Also in an exemplary embodiment, the method further includes obtaining additional sensor data via one or more additional sensors of the vehicle; determining, via the processor using the additional sensor data, whether a human is detected in proximity to the vehicle as the action occurs; and wherein the facilitating of the communications between the owner of the vehicle and the external actor only upon a further condition that a human is detected as the action occurs.

Also in an exemplary embodiment, the method further includes placing the vehicle in a low energy usage mode, when it is not determined that a human is detected as the action occurs, in accordance with instructions provided by the processor; and placing the vehicle out of the low energy usage mode, when a human is detected as the action occurs, in accordance with instructions provided by the processor.

Also in an exemplary embodiment, the additional sensor data is obtained via one or more cameras of the vehicle.

Also in an exemplary embodiment, the additional sensor data is obtained via one or more biosensors of the vehicle.

Also in an exemplary embodiment, the facilitating of the communications between the owner of the vehicle and the external actor includes providing a quick response (QR) code display for the external actor after both the action is detected and the human is detected; receiving a summary from the external actor as to a circumstance surrounding the vehicle, in response to the QR code display; and facilitating the communications between the owner of the vehicle and the external actor based on a decision of the owner of the vehicle as to whether to accept the communications with the external actor based on the summary provided from the external actor.

Also in an exemplary embodiment, the virtual chatbot is performed by providing a virtual chatroom via the remote server when selected by the owner of the vehicle based on the decision of the owner of the vehicle for text communications with the external actor.

Also in an exemplary embodiment, the virtual chatbot is performed by providing a voice over Internet protocol (VOIP) telephone number via the remote server when selected by the owner of the vehicle based on the decision of the owner of the vehicle for voice communications with the external actor.

In another exemplary embodiment, a system is provided that includes a processor of a vehicle and one or more sensors of the vehicle. The processor is configured to at least facilitate providing instructions for a notification proximate a vehicle that is parked, the notification including an instruction for an external actor to take an action in order to initiate communications with an owner of the vehicle. The one or more sensors of the vehicle that are configured to obtain sensor data detecting when the action has been taken. The processor is further configured to facilitate the communications between the owner of the vehicle and the external actor upon detection of the action taken by the external actor, via a virtual chatbot via a remote server that protects contact information of the owner of the vehicle, in accordance with instructions provided by the processor.

Also in an exemplary embodiment, the action includes a knocking of a windshield of the vehicle by the external actor; the notification includes the instruction for the external actor to knock on the windshield to initiate the communications with the owner of the vehicle; and the action is detected based on microphone data obtained via a plurality of microphones of the vehicle, and via a comparison via the processor of the microphone data with one or more known sound signatures that are stored in memory and that correspond to knocking of the windshield.

Also in an exemplary embodiment, the system further includes one or more additional sensors of the vehicle that are configured to obtain additional sensor data; and the processor is further configured to at least facilitate determining, using the additional sensor data, whether a human is detected in proximity to the vehicle as the action occurs; and facilitating the communications between the owner of the vehicle and the external actor only upon a further condition that a human is detected as the action occurs.

Also in an exemplary embodiment, the processor is further configured to at least facilitate placing the vehicle in a low energy usage mode, when it is not determined that a human is detected as the action occurs, in accordance with instructions provided by the processor; and placing the vehicle out of the low energy usage mode, when a human is detected as the action occurs, in accordance with instructions provided by the processor.

Also in an exemplary embodiment, the one or more additional sensors include one or more cameras of the vehicle.

Also in an exemplary embodiment, the one or more additional sensors include one or more biosensors of the vehicle.

Also in an exemplary embodiment, the processor is further configured to facilitate the communications between the owner of the vehicle and the external actor by providing a quick response (QR) code display for the external actor after both the action is detected and the human is detected; receiving a summary from the external actor as to a circumstance surrounding the vehicle, in response to the QR code display; and facilitating the communications between the owner of the vehicle and the external actor based on a decision of the owner of the vehicle as to whether to accept the communications with the external actor based on the summary provided from the external actor.

Also in an exemplary embodiment, the processor is further configured to facilitate the communications between the owner of the vehicle and the external actor via the virtual chatbot by providing a virtual chatroom via the remote server when selected by the owner of the vehicle based on the decision of the owner of the vehicle for text communications with the external actor.

Also in an exemplary embodiment, the processor is further configured to facilitate the communications between the owner of the vehicle and the external actor via the virtual chatbot by providing a voice over Internet protocol (VOIP) telephone number via the remote server when selected by the owner of the vehicle based on the decision of the owner of the vehicle for voice communications with the external actor.

In another exemplary embodiment, a vehicle is provided that includes a body, a propulsion disposed within the body and configured to move the vehicle; a windshield disposed on the body; a plurality of microphones configured to obtain microphone sensor data as to a sound made against the windshield; one or more additional sensors configured to obtain additional sensor data as to a external actor in proximity to the vehicle as the sound is made; and a processor that is coupled to the plurality of microphones, to the one or more additional sensors, and to a remote server that is remote from the vehicle, the processor configured to at least facilitate providing instructions for a notification proximate the vehicle as it is parked, the notification including an instruction for an external actor to take an action by knocking on the windshield in order to initiate communications with an owner of the vehicle; and determining when the action has occurred based on the microphone sensor data, and based on a comparison of the microphone sensor data with a known sound signature for knocking on the windshield that is stored in memory; determining whether a human is detected in proximity to the vehicle as the action occurs, based on the additional sensor data; and facilitating the communications between the owner of the vehicle and the external actor upon occurrence of the action occurring and the detecting of the human in proximity to the vehicle as the action occurs, via a virtual chatbot via the remote server that protects contact information of the owner of the vehicle, in accordance with instructions provided by the processor.

Also in an exemplary embodiment, the processor is further configured to at least facilitate providing a quick response (QR) code display for the external actor after both the action is detected and the human is detected; receiving a summary from the external actor as to a circumstance surrounding the vehicle, in response to the QR code display; and facilitating the communications between the owner of the vehicle and the external actor based on a decision of the owner of the vehicle as to whether to accept the communications with the external actor based on the summary provided from the external actor, including by facilitating the communications between the owner of the vehicle and the external actor via the virtual chatbot by providing a virtual chatroom via the remote server when selected by the owner of the vehicle based on the decision of the owner of the vehicle for text communications with the external actor; and facilitating the communications between the owner of the vehicle and the external actor via the virtual chatbot by providing a voice over Internet protocol (VOIP) telephone number via the remote server when selected by the owner of the vehicle based on the decision of the owner of the vehicle for voice communications with the external actor.

### DESCRIPTION OF THE DRAWINGS

The present disclosure will hereinafter be described in conjunction with the following drawing figures, wherein like numerals denote like elements, and wherein:

FIG. 1 is a functional block diagram of a system, including a vehicle and a remote server, that is configured for facilitating communications between an external actor and an owner of the vehicle when the vehicle is parked, in accordance with an exemplary embodiment;

FIG. 2 is an illustration of an exemplary arrangement of microphones of the vehicle of FIG. 1, in accordance with an exemplary embodiment;

FIG. 3 is an illustration of an exemplary arrangement of cameras of the vehicle of FIG. 1, in accordance with an exemplary embodiment;

FIG. 4 is an illustration of an exemplary display provided by the display system of the vehicle of FIG. 1, in accordance with an exemplary embodiment;

FIG. 5 is a flowchart of a process for facilitating communications between an external actor and an owner of a vehicle when the vehicle is parked, and that can be implemented in connection with the system of FIG. 1, including the vehicle thereof and the implementations of FIGS. 2-4, in accordance with an exemplary embodiment; and

FIG. 6 is an illustration of an exemplary implementation of a chatbot for communications between the external actor and the owner as part of the process of FIG. 5 as implemented in connection with the system of FIG. 1, including the vehicle thereof and the implementations of FIGS. 2-4, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

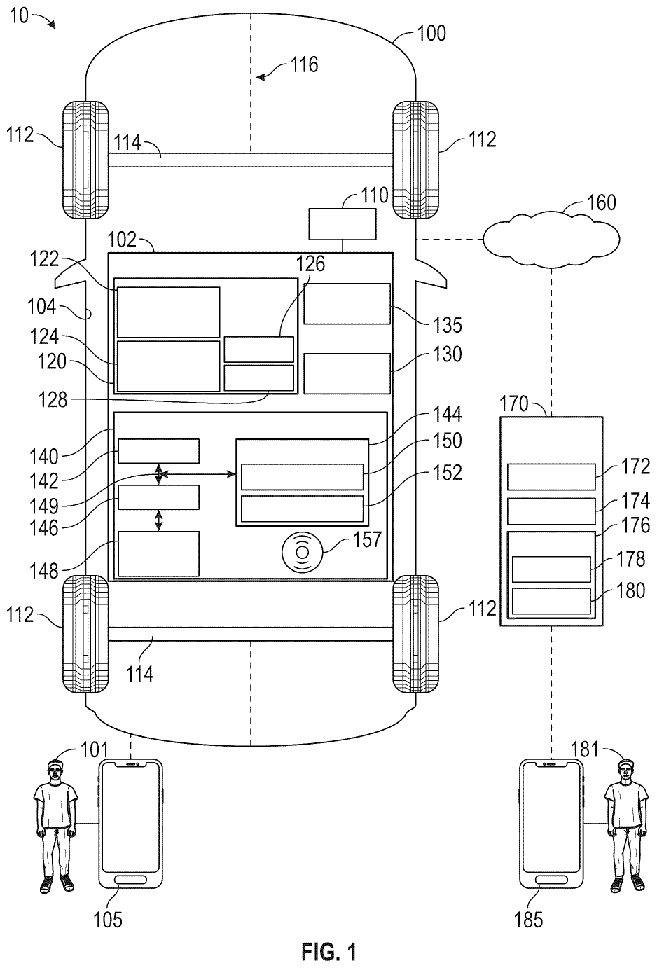

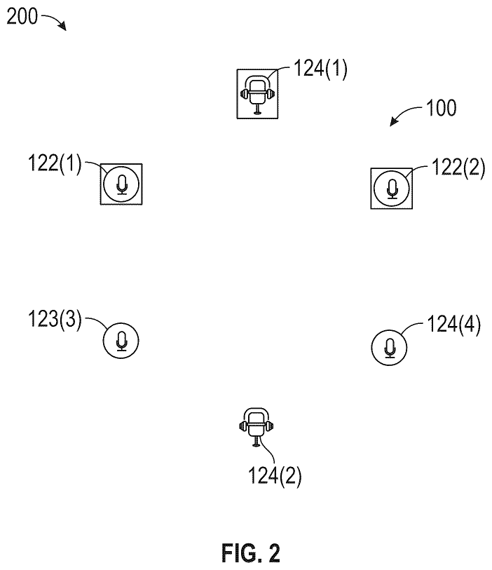

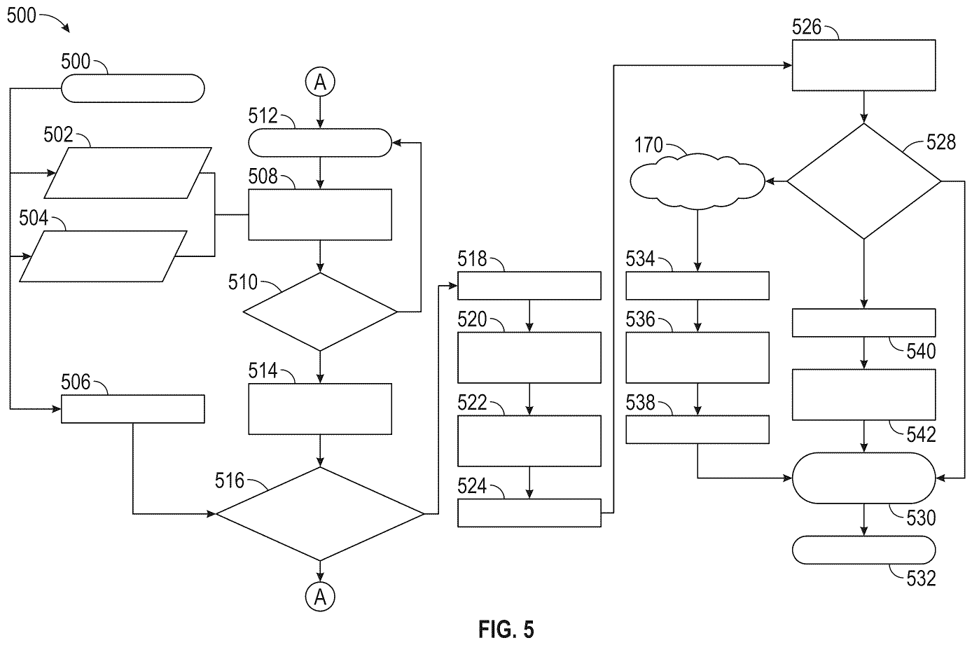

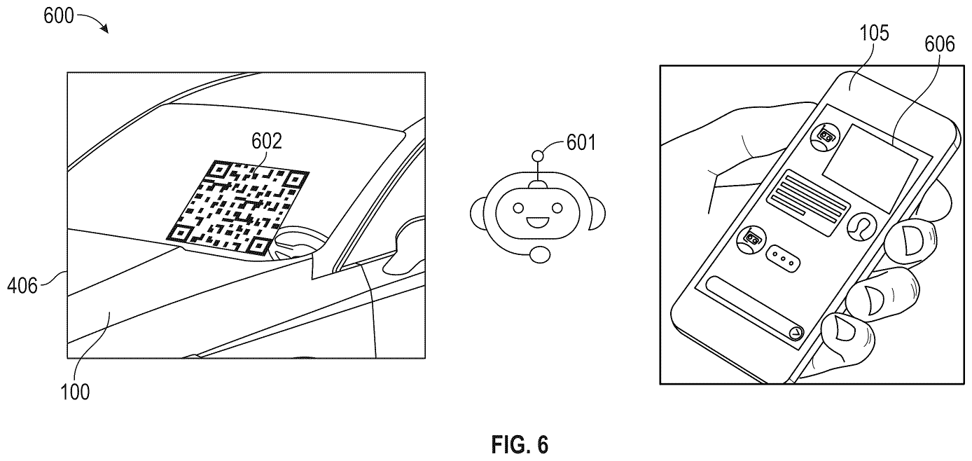

FIG. 1 illustrates a system 10. In various embodiments, and as described below, the system 10 includes vehicle 100 and a remote server 170. In various embodiments, the vehicle 100 depicted is represented as a representative vehicle of a fleet of vehicles 100. Also in various embodiments, the system 10 provides for facilitating communications between an external actor 101 and an owner 181 of the vehicle 100 when the vehicle 100 is parked. As used herein, an “external actor” refers to an individual in proximity to the vehicle 100 that is not the owner but wishes or needs to contact the owner, whereas an “owner” refers to an owner of the vehicle and/or in certain embodiments a user or manager of the vehicle 100 (e.g., a renter of the vehicle 100, a driver of the vehicle 100, a fleet manager, or the like). In certain embodiments, the facilitated communications occur also at least in part using an electronic device 105 of the external actor 101 (e.g., a smart phone or other electronic device of the external actor 101) and an electronic device 185 of the owner 181 (e.g., a smart phone or other electronic device of the owner 181). In various embodiments, the system 10 performs these tasks in accordance with the vehicle implementations of illustrations 200, 300, and 400 of FIGS. 2-4 along with the process 500 of FIG. 5 and the implementation thereof of FIG. 6, in accordance with exemplary embodiments.

In various embodiments, each vehicle 100 comprises an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise a motorcycle or other vehicle, such as aircraft, spacecraft, watercraft, and so on, and/or one or more other types of mobile platforms (e.g., a robot and/or other mobile platform).

In the depicted embodiment, the vehicle 100 includes a body 104 that is arranged on a chassis 116. The body 104 substantially encloses other components of the vehicle 100. The body 104 and the chassis 116 may jointly form a frame. The vehicle 100 also includes a drive system 110 and a plurality of wheels 112. In various embodiments, the drive system 110 is mounted on the chassis 116, and drives the wheels 112, for example via axles 114, to cause movement and propulsion of the vehicle 100.

As noted above, the control system 102 facilitates communication between the external actor 101 and the owner 181 of the vehicle 100 when the vehicle 100 is parked. As depicted in FIG. 1, in various embodiments, the control system 102 includes a sensor array 120, a display 130, a transceiver 135, and a controller 140.

In various embodiments, the sensor array 120 obtains sensor data pertaining to the vehicle 100, including pertaining to the external actor 101's interaction with the vehicle 100. In various embodiments, the sensor array 120 includes interior microphones 122, exterior microphones 124, and cameras 126. In certain embodiments, the sensor array 120 may also include other sensors 128.

In various embodiments, the interior microphones 122 and the exterior microphones 124 detect sounds made by external actors 101 in proximity to the vehicle 100, including by an external actor 101 desiring to communicate with an owner 181 of the vehicle 100 when the vehicle is parked. In various embodiments, the interior microphones 122 and the exterior microphones 124 are configured to detect a knocking sound by the external actor 101 on a windshield of the vehicle 100, and/or some other preselected sound to communicate with the owner 181. In various embodiments, the interior microphones 122 are disposed on or within an interior of the vehicle 100 (e.g., inside a passenger cabin of the vehicle 100), whereas the exterior microphones 124 are disposed on or within an exterior of the vehicle 100 (e.g., on the outer body of the vehicle 100 and/or otherwise outside the passenger cabin of the vehicle 100).

With reference to FIG. 2, an illustration 200 is provided as to an exemplary arrangement of the interior microphones 122 and the exterior microphones 124 of the vehicle 100, in accordance with an exemplary embodiment. As depicted in FIG. 2, in an exemplary embodiment, a first exterior microphone 124(1) is disposed on or proximate a front end or region of the vehicle 100, and a second exterior microphone 124(2) is disposed on or proximate a rear end of the vehicle 100. Also as depicted in FIG. 2, in an exemplary embodiment, a first interior microphone 122(1) is disposed proximate a front driver side seat of the vehicle 100; a second interior microphone 122(2) is disposed proximate a front passenger side seat of the vehicle 100; a third interior microphone 122(3) is disposed proximate a rear driver side seat of the vehicle 100; and a fourth interior microphone 122(4) is disposed proximate a rear passenger side seat of the vehicle 100. It will be appreciated that the number and/or placement of exterior microphones 124 and/or interior microphones 122 may vary in different embodiments.

With reference back to FIG. 1, in various embodiments the cameras 126 obtain camera images pertaining to external actors 101 in proximity to the vehicle 100, including an external actor 101 desiring to communicate with an owner 181 of the vehicle 100 when the vehicle is parked. In various embodiments, the cameras 126 are configured to obtain the camera images as the external actor 101 is knocking on the windshield and/or otherwise attempting to interact with the vehicle 100. In various embodiments, the cameras 126 are disposed on or within the vehicle 100 (e.g., on the body 104 thereof in certain embodiments), and face in one or more directions outside the vehicle 100 (e.g., outside the passenger cabin of the vehicle 100).

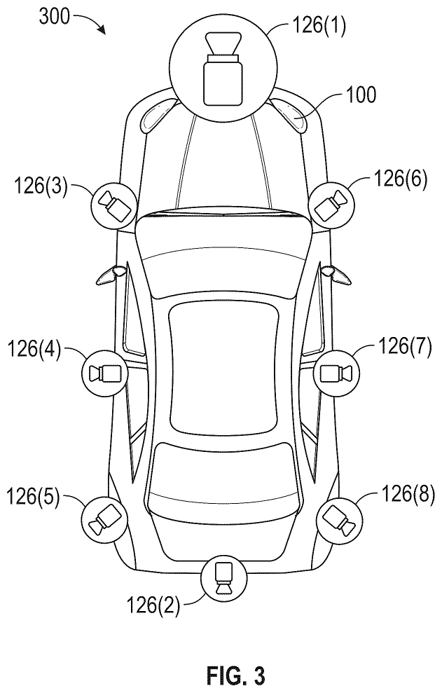

With reference to FIG. 3, an illustration 300 is provided as to an exemplary arrangement of the cameras 126 of the vehicle 100, in accordance with an exemplary embodiment. As depicted in FIG. 3, in an exemplary embodiment, a first camera 126(1) is disposed on or proximate a front end or region of the vehicle 100, and a second exterior camera 126(2) is disposed on or proximate a rear end of the vehicle 100. Also as depicted in FIG. 3, driver side cameras 126(3), 126(4), and 126(5) are disposed on a driver side of the vehicle 100, and passenger side cameras 126(6), 126(7), and 126(8) are disposed on a passenger side of the vehicle 100. It will be appreciated that the number and/or placement of cameras 126 may vary in different embodiments.

With reference back to FIG. 1, in various embodiments the sensor array 120 may also include one or more other sensors 128. In certain embodiments, the other sensors 128 may include additional sensors that are able to likewise detect whether the sound (e.g., against the windshield) is made by a human. For example, in certain embodiments, the other sensors 128 may include one or more infrared sensors, biosensors, sonar sensor, radar sensors, Lidar sensors, or the like.

With continued reference to FIG. 1, in various embodiments the display 130 includes one or more devices and/or systems that provide information for the external actor 101 that is attempting to communicate with the owner 181 of the vehicle 100 as the vehicle 100 is parked. In certain embodiments, the display 130 includes a display screen, a pop-up display, and/or other visual display that is configured to provide a visual notification for the external actor 101 with instructions to follow (e.g., knocking on the windshield) to initiate communication with the owner 181 of the vehicle 100.

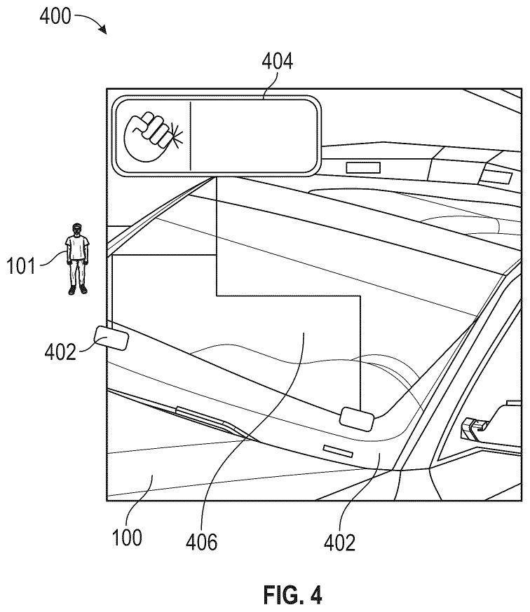

For example, with reference to FIG. 4, an illustration 400 is provided of one such implementation of a notification provided by the display 130 for the external actor 101. As depicted in FIG. 4, in an exemplary embodiment, a display screen and/or projector 402 on the windshield 406 provides a visual notification 404 for the external actor 101. In one such embodiment, the visual notification 404 provides instructions, such as “Please Knock”, for the external actor 101. As shown in FIG. 5, in various embodiments, the use of the visual notification 404 with the instructions (e.g., “Please Knock”) facilitates communications between the parties while protecting the personal information (including contact information of the vehicle owner 181). It will be appreciated that the type, location, and/or manner of the notification 404 may vary in different embodiments.

With reference back to FIG. 1, in certain embodiments the display 130 may instead provide one or more other types of notifications, such as one or more audio notifications. In such embodiments, the display 130 may include a speaker that provides such instructions (e.g., “Please Knock” in a verbal manner.

With continued reference to FIG. 1, in various embodiments the vehicle 100 also includes a transceiver 135. In various embodiments, the transceiver 135 communicates with the remote server 170 with information pertaining to the request from the external actor 101 for communication with the vehicle owner 181. In various embodiments, the transceiver 135 further facilitates communications between the remote server 170 and the external actor 101, including the exchange of information therebetween.

In certain embodiments, the display 130 provides information pertaining to the vehicle 100, including for communicating instructions and/or controls from the remote server 170 and/or the owner 181 of the vehicle 100 to the external actor 101.

In various embodiments, the controller 140 is coupled to the sensor array 120, as well as to the display 130 and the transceiver 135 (e.g., including for obtaining the sensor data, processing the sensor data, and facilitating communications between the external actor 101 and the vehicle owner 181 via the remote server 170).

In various embodiments, the controller 140 comprises a computer system, and includes a processor 142, a memory 144, an interface 146, a storage device 148, and a computer bus 149. In various embodiments, the controller (or computer system) 140 obtains sensor data from the sensor array 120, and in certain embodiments additional data via the transceiver 135 (e.g., as to the owner 181 of the vehicle 100). In various embodiments, the controller 140 processes the data, including the request from the external actor 101 for communication with the vehicle owner 181, and facilitates communications between the external actor 101 and the owner 181 of the vehicle 100 via the remote server 170. In various embodiments, the controller 140 provides these and other functions in accordance with the steps of the processes and implementations depicted in FIG. 5 and the implementation of FIG. 6 and as described further below in connection therewith.

In various embodiments, the controller 140 (and, in certain embodiments, the control system 102 itself) is disposed within the body 104 of the vehicle 100. In one embodiment, the control system 102 is mounted on the chassis 116. In certain embodiments, the controller 140 and/or control system 102 and/or one or more components thereof may be disposed outside the body 104, for example on a remote server, in the cloud, or other device where image processing is performed remotely. In certain embodiments, the controller 140 of the vehicle 100 also performs functions in concert with the remote server 170, described further below.

It will be appreciated that the controller 140 may otherwise differ from the embodiment depicted in FIG. 1. For example, the controller 140 may be coupled to or may otherwise utilize one or more remote computer systems and/or other control systems, for example as part of one or more of the above-identified vehicle 100 devices and systems.

In the depicted embodiment, the computer system of the controller 140 includes a processor 142, a memory 144, an interface 146, a storage device 148, and a bus 149. The processor 142 performs the computation and control functions of the controller 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 150 contained within the memory 144 and, as such, controls the general operation of the controller 140 and the computer system of the controller 140, generally in executing the processes described herein, such as the processes and implementations depicted in FIGS. 5 and 6 and as described further below in connection therewith.

The memory 144 can be any type of suitable memory. For example, the memory 144 may include various types of dynamic random access memory (DRAM) such as SDRAM, the various types of static RAM (SRAM), and the various types of non-volatile memory (PROM, EPROM, and flash). In certain examples, the memory 144 is located on and/or co-located on the same computer chip as the processor 142. In the depicted embodiment, the memory 144 stores the above-referenced program 150 along with stored values 152 (e.g., including in various embodiments, data pertaining to the external actor 101, the vehicle 100, and the owner 181 of the vehicle 100, along with threshold values and/or other values for the processing of the data as set forth in the processes and implementations depicted in FIGS. 5 and 6 and as described further below in connection therewith in accordance with exemplary embodiments).

The bus 149 serves to transmit programs, data, status and other information or signals between the various components of the computer system of the controller 140. The interface 146 allows communication to the computer system of the controller 140, for example from a system driver and/or another computer system, and can be implemented using any suitable method and apparatus. In one embodiment, the interface 146 obtains the various data from the sensor array 120 and/or from one or more other sources (e.g., from the remote server 170 and/or one or more electronic devices 105, 185). The interface 146 can include one or more network interfaces to communicate with other systems or components. The interface 146 may also include one or more network interfaces to communicate with technicians, and/or one or more storage interfaces to connect to storage apparatuses, such as the storage device 148.

The storage device 148 can be any suitable type of storage apparatus, including various different types of direct access storage and/or other memory devices. In one exemplary embodiment, the storage device 148 comprises a program product from which memory 144 can receive a program 150 that executes one or more embodiments of the processes and implementations of FIGS. 5 and 6 and as described further below in connection therewith. In another exemplary embodiment, the program product may be directly stored in and/or otherwise accessed by the memory 144 and/or a secondary storage device (e.g., disk 157), such as that referenced below.

The bus 149 can be any suitable physical or logical means of connecting computer systems and components. This includes, but is not limited to, direct hard-wired connections, fiber optics, infrared and wireless bus technologies. During operation, the program 150 is stored in the memory 144 and executed by the processor 142.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 140 may also otherwise differ from the embodiment depicted in FIG. 1, for example in that the computer system of the controller 140 may be coupled to or may otherwise utilize one or more remote computer systems and/or other control systems.

With continued reference to FIG. 1, in various embodiments the vehicle 100 and the remote server 170 communicate via one or more communications networks 160. In various embodiments, the communications networks 160 may include one or more wireless communications networks (e.g., satellite-based, cellular, and/or any number of other different types of wireless communications networks).

Also in various embodiments, the remote server 170 is disposed remote from, or a significant physical distance from, the vehicle 100. In various embodiments, as depicted in FIG. 1, the remote server 170 includes one or more transceivers 172, processors 174, and computer memory 176 storing a program 178 and stored values 180. In various embodiments, the transceiver 172 is utilized to communicate with the vehicle 100, and to also facilitate communications between the vehicle owner 181 and the external actor 101. As depicted in FIG. 1, the transceiver 172, processor 174, memory 176, program 178, and stored values 180 are similar or identical to the corresponding features of the vehicle 100 (e.g., as to the transceiver 135, processor 142, memory 144, program 150, and stored values 152 thereof).

FIG. 5 is a flowchart of a process 500 for generating and aggregating data from a fleet of vehicles and their external environment, and that can be used in managing and controlling the vehicles in the fleet, in accordance with an exemplary embodiment. The process 500 of FIG. 5 is described in greater detail below in connection with FIG. 5 as well as FIG. 6 (which provides an illustration of an exemplary chatbot utilized in connection with the process 500 of FIG. 5).

As depicted in FIG. 5, in various embodiments the process 500 begins at step 502. In various embodiments, the process 500 begins when the vehicle 100 is parked and one or more individuals approach the vehicle 100.

In various embodiments, exterior microphone data is collected (step 502). In various embodiments, exterior microphone data is collected via the exterior microphones 124 of FIGS. 1 and 2 as to sounds in proximity to the vehicle 100 as the vehicle 100 is parked.

Also in various embodiments, interior microphone data is collected (step 504). In various embodiments, interior microphone data is collected via the interior microphones 122 of FIGS. 1 and 2 as to sounds in proximity to the vehicle 100 as the vehicle 100 is parked.

In addition, in various embodiments, additional sensor data is obtained (step 506). In various embodiments, additional sensor data includes camera images obtained via the cameras 126 of FIGS. 1 and 3 as to individuals in proximity to the vehicle 100 that are causing sounds to be made (e.g., via external actors that are causing the sounds to be made that are captured by the exterior microphones 124 and interior microphones 122) as the vehicle 100 is parked. In certain embodiments, the sensor data of step 506 may also be collected via one or more other sensors, such as one or more infrared sensors, biosensors, and/or other sensors 128 such as those described above in connection with the sensor array 120 of FIG. 1

In various embodiments, monitoring is performed (step 508). In certain embodiments, monitoring is performed as to whether any sounds are detected in proximity to the vehicle 100 that include a sound signature that is consistent with an expected sound of an external actor that requests communication with the vehicle owner. In certain such embodiments, the monitoring is performed with respect to sounds on or associated with the windshield of the vehicle 100, such as a knocking on the vehicle 100, for example in accordance with the exemplary display associated with illustration 400 of FIG. 4 in which the external actor is requested to knock on the windshield if he or she wishes to communicate with the owner of the vehicle 100. In various embodiments, the monitoring is performed via one or more processors (such as the processor 142 and/or processor 174 of FIG. 1) using the microphone data of steps 502 and 504.

In various embodiments, a determination is made as to whether a match is detected (step 510). Specifically, in various embodiments, a determination is made as to whether one or more sounds detected in steps 502 and/or 504 have a sound signature that is consistent with a requested sound (e.g., a knock on the windshield). In various embodiments, this determination is made by one or more processors (such as the processor 142 and/or processor 174 of FIG. 1) in comparing the detected sounds with known sound signatures that are stored as stored values in memory (e.g., stored values 152 and/or stored values 180 in the memory 144 and/or memory 176 of FIG. 1).

In various embodiments, if it is determined in step 510 that a match is not detected, then in various embodiments the ignition of the vehicle 100 is turned off, and the vehicle 100 enters a “sleep” or other lower energy usage mode (step 512), as the monitoring of step 508 continues. In various embodiments, this is performed determination is made by one or more processors (such as the processor 142 and/or processor 174 of FIG. 1).

In various embodiments, once it is determined in step 510 that a match is detected, then the vehicle 100 wakes up and exits the low energy usage mode (step 514). In various embodiments, this is performed via one or more processors (such as the processor 142 and/or processor 174 of FIG. 1).

Also in various embodiments, as the vehicle 100 has woken up, a determination is made as to whether a human presence is detected (step 516). In various embodiments, during step 516, a determination is made using the sensor data of step 506 (e.g., camera images in certain embodiments, and/or infrared, biosensing, and/or other sensor data in other embodiments) as to whether a human is detected in proximity to the vehicle 100 (e.g., in certain embodiments, whether a human is detected in proximity to the windshield of the vehicle 100 corresponding to the knocking sound on the windshield). Also in various embodiments, this determination is made via one or more processors (such as the processor 142 and/or processor 174 of FIG. 1) using the camera images and/or other sensor data of step 506.

In various embodiments, if it is determined in step 516 that a human presence is not detected, then in various embodiments the process proceeds to the above-described step 512, and the process 500 continues with continued monitoring in the sleep and/or low energy usage mode.

Conversely, if it is instead determined in step 516 that a human presence is detected, then the process 500 instead proceeds to step 518, as described below.

In various embodiments, during step 518, a notification is provided to initiate communications. Specifically, in various embodiments, a notification is provided with an instruction for the external actor to follow for communication with the vehicle owner. In certain embodiments, a quick response (“QR”) code display is provided proximate the windshield of the vehicle 100 of FIG. 1 for the external actor 101 to utilize via his or her electronic device 105. In various embodiments, the QR code display and/or other notification are provided via the display 130 of FIG. 1 (e.g., on a display screen, pop-up display, or the like) in accordance with instructions provide by a processor (such as the processor 142 and/or processor 174 of FIG. 1).

Also in various embodiments, communications are commenced between the external actor and the vehicle owner (step 520). Specifically, in various embodiments, once the QR code is scanned (e.g., via the electronic device 105 of the external actor 101), a dynamic chatbot is generated during step 520 for communications between the external actor 101 and the vehicle 181, via their respective electronic devices 105, 185. In various embodiments, this is performed via a processor (such as the processor 142 and/or processor 174 of FIG. 1).

Also in various embodiments, an automated message is provided for the external actor (step 522). In various embodiments, the automated message comprises a preset message (e.g., a pre-recorded audio message and/or pre-selected written message) from the owner to the external actor that is delivered via the chatbot and that is presented to the external actor 101 of FIG. 1 via his or her electronic device 105. In one exemplary embodiment, the automated message may include an estimated time in which the owner will be back to the vehicle 100, along with an invitation for the external actor to explain the circumstances and/or what is desired. For example, in certain embodiments, the automated message may include a message such as “I will back at 3:00 pm, how can I help you”, or a similar message along those lines. In various embodiments, the automated message is facilitated via instructions provide by a processor (such as the processor 142 and/or processor 174 of FIG. 1).

With reference to FIG. 6, an illustration 600 is provided with respect to the initial chatbot communications as set forth above in connection with steps 520 and 522, in accordance with an exemplary embodiment. For example, in the depicted embodiment of FIG. 6, a QR code graphic 602 is presented on the windshield 406 of the vehicle 100 for the external actor. Also as depicted in FIG. 6, in an exemplary embodiment, once the external actor clicks on the QR code graphic 602, a chatbot 601 is initiated between the owner and the external actor, including with an initial message from 606 that is provided to the electronic device 105 of the external actor 101 (e.g., with an indication as to when the owner 181 will return to the vehicle 100, and with an inquiry as to the circumstances of the external actors 101's request). As shown in FIG. 6, in various embodiments, the use of the chatbot 601 and the QR code graphic 602 facilitates communications between the parties while protecting the personal information (including contact information of the vehicle owner).

With reference back to FIG. 5, in various embodiments the request is classified (step 524). Specifically, in various embodiments, a response from the external actor (i.e., his or her response to the automated message of step 522) is received in step 524 regarding a summary of the circumstances surrounding the parked vehicle 100, and is classified as to a type of request. For example, in various embodiments, the request from the external actor may be classified as pertaining to a vehicle event, a parking situation, a request to move the vehicle, and/or the like pertaining to the vehicle 100. In various embodiments, the request is received and classified via the chatbot by one or more processors (such as the processor 142 and/or processor 174 of FIG. 1).

In various embodiments, a notification is provided to the owner (step 526). Specifically, in various embodiments, a notification is provided to the vehicle owner as to the nature of the request, based on the classification of step 526. In various embodiments, the notification is provided to the electronic device 185 of the vehicle owner 181 of FIG. 1, such as via the communications network 160 and the remote server 170.

In various embodiments, a determination is made as to whether the owner has accepted communications with the external actor (step 528). Specifically, in various embodiments, once the owner has received the notification of step 526 and has responded to the notification based on the summary provided by the external actor, determinations are made as to whether the vehicle owner accepts direct communications with the external actor, and what type(s) of communications the owner has accepted with the external actor (e.g., including for an audio call for voice communications with the external actor or an exchange of text messages for text communications with the external actor). In various embodiments, these determinations are made by one or more processors (such as the processor 142 and/or processor 174 of FIG. 1).

In various embodiments, if it is determined in step 528 that the owner has not accepted communications with the external actor, the communications are terminated between the vehicle and the external actor (step 530). In various embodiments, this is accomplished in accordance with instructions provided by one or more processors (such as the processor 142 and/or processor 174 of FIG. 1). In various embodiments, the process 500 then terminates at 532.

In various embodiments, if it is instead determined in step 528 that the owner has accepted voice calling communications with the external actor, then the process instead proceeds to step 534, in which voice communications are initiated between the external actor and the vehicle owner. Specifically, in various embodiments, the remote server 170 (e.g., via instructions provided by the processor 174 thereof) initiates a virtual telephone number for voice communications, such as a voice over Internet protocol (VOIP) for voice communications between the vehicle owner and the external actor. In various embodiments, the VOIP number is provided between the vehicle owner and the external actor via the Chatbot (step 536), and the phone call is provided between the external actor and the vehicle owner for the voice communications pertaining to the vehicle 100 (i.e., via their respective electronic devices 105 and 185 in various embodiments) (step 538). In various embodiments, following the VOIP telephone call, the communications are terminated between the vehicle and the external actor at step 530, and the process 500 then terminates at 532.

Conversely, in various embodiments, if it is instead determined in step 528 that the owner has accepted text communications with the external actor, then the process instead proceeds to step 540, in which text communications are initiated between the external actor and the vehicle owner. Specifically, in various embodiments, the remote server 170 (e.g., via instructions provided by the processor 174 thereof) initiates a virtual chat room for text communications between the external actor and the vehicle owner (i.e., via their respective electronic devices 105 and 185 in various embodiments). In various embodiments, text communications are provided between the vehicle owner and the external actor via the chat room (step 542). In various embodiments, following the text communications in the chat room, the communications are terminated between the vehicle and the external actor at step 530, and the process 500 then terminates at 532.

Accordingly, methods, systems, and vehicles are provided for facilitating communications between an external actor and a vehicle owner pertaining to the vehicle of the owner as the vehicle is parked (e.g., when the external actor needs or desires to contact the vehicle owner pertaining to a condition or event pertaining to the vehicle as it is parked). In various embodiments, the personal information (e.g., the contact information as to the vehicle owner) is protected, as the vehicle owner need not leave his or her name, telephone number, or other personal information visible as the vehicle 100 is parked (and instead, a virtual chatbot is utilized along with a QR code display and other non-identifying notifications to facilitate communications between the external actor and the vehicle owner).

It will be appreciated that the systems, vehicles, and methods may vary from those depicted in the Figures and described herein. For example, the system 10 of FIG. 1, including the vehicle 100, the control system thereof, and the remote server 170 of FIG. 1 and components thereof, may differ from that depicted in FIG. 1 as well as the exemplary implementations thereof of FIGS. 2-4. It will similarly be appreciated that the steps of the processes and implementations of FIGS. 5 and 6 may differ from those depicted in the Figures, and/or that various steps may occur concurrently and/or in a different order than that depicted in the Figures.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method comprising:
providing, via instructions provided by a processor, a notification proximate a vehicle that is parked, the notification comprising an instruction for an external actor to take an action in order to initiate communications with an owner of the vehicle;
detecting, via one or more sensors of the vehicle, when the action has been taken via sensor data obtained via the one or more sensors; and
facilitating the communications between the owner of the vehicle and the external actor upon detection of the action taken by the external actor, via a virtual chatbot via a remote server that protects contact information of the owner of the vehicle, in accordance with instructions provided by the processor.

2. The method of claim 1, wherein:
the action comprises a knocking of a windshield of the vehicle by the external actor;
the notification comprises the instruction for the external actor to knock on the windshield to initiate the communications with the owner of the vehicle; and
the action is detected based on microphone data obtained via a plurality of microphones of the vehicle, and via a comparison via the processor of the microphone data with one or more known sound signatures that are stored in memory and that correspond to knocking of the windshield.

3. The method of claim 1, further comprising:
obtaining additional sensor data via one or more additional sensors of the vehicle;
determining, via the processor using the additional sensor data, whether a human is detected in proximity to the vehicle as the action occurs; and
wherein the facilitating of the communications between the owner of the vehicle and the external actor only upon a further condition that a human is detected as the action occurs.

4. The method of claim 3, further comprising:
placing the vehicle in a low energy usage mode, when it is not determined that a human is detected as the action occurs, in accordance with instructions provided by the processor; and
placing the vehicle out of the low energy usage mode, when a human is detected as the action occurs, in accordance with instructions provided by the processor.

5. The method of claim 3, wherein the additional sensor data is obtained via one or more cameras of the vehicle.

6. The method of claim 3, wherein the additional sensor data is obtained via one or more biosensors of the vehicle.

7. The method of claim 3, wherein the facilitating of the communications between the owner of the vehicle and the external actor comprises:
providing a quick response (QR) code display for the external actor after both the action is detected and the human is detected;
receiving a summary from the external actor as to a circumstance surrounding the vehicle, in response to the QR code display; and
facilitating the communications between the owner of the vehicle and the external actor based on a decision of the owner of the vehicle as to whether to accept the communications with the external actor based on the summary provided from the external actor.

8. The method of claim 7, wherein the virtual chatbot is performed by providing a virtual chatroom via the remote server when selected by the owner of the vehicle based on the decision of the owner of the vehicle for text communications with the external actor.

9. The method of claim 7, wherein the virtual chatbot is performed by providing a voice over Internet protocol (VOIP) telephone number via the remote server when selected by the owner of the vehicle based on the decision of the owner of the vehicle for voice communications with the external actor.

10. A system comprising:
a processor configured to at least facilitate providing instructions for a notification proximate a vehicle that is parked, the notification comprising an instruction for an external actor to take an action in order to initiate communications with an owner of the vehicle; and
one or more sensors of the vehicle that are configured to obtain sensor data detecting when the action has been taken;
wherein the processor is further configured to facilitate the communications between the owner of the vehicle and the external actor upon detection of the action taken by the external actor, via a virtual chatbot via a remote server that protects contact information of the owner of the vehicle, in accordance with instructions provided by the processor.

11. The system of claim 10, wherein:
the action comprises a knocking of a windshield of the vehicle by the external actor;
the notification comprises the instruction for the external actor to knock on the windshield to initiate the communications with the owner of the vehicle; and
the action is detected based on microphone data obtained via a plurality of microphones of the vehicle, and via a comparison via the processor of the microphone data with one or more known sound signatures that are stored in memory and that correspond to knocking of the windshield.

12. The system of claim 10, further comprising:
one or more additional sensors of the vehicle that are configured to obtain additional sensor data;
wherein the processor is further configured to at least facilitate:
determining, using the additional sensor data, whether a human is detected in proximity to the vehicle as the action occurs; and
facilitating the communications between the owner of the vehicle and the external actor only upon a further condition that a human is detected as the action occurs.

13. The system of claim 12, wherein the processor is further configured to at least facilitate:
placing the vehicle in a low energy usage mode, when it is not determined that a human is detected as the action occurs, in accordance with instructions provided by the processor; and
placing the vehicle out of the low energy usage mode, when a human is detected as the action occurs, in accordance with instructions provided by the processor.

14. The system of claim 12, wherein the one or more additional sensors comprise one or more cameras of the vehicle.

15. The system of claim 12, wherein the one or more additional sensors comprise one or more biosensors of the vehicle.

16. The system of claim 15, wherein the processor is further configured to facilitate the communications between the owner of the vehicle and the external actor by:
providing a quick response (QR) code display for the external actor after both the action is detected and the human is detected;
receiving a summary from the external actor as to a circumstance surrounding the vehicle, in response to the QR code display; and
facilitating the communications between the owner of the vehicle and the external actor based on a decision of the owner of the vehicle as to whether to accept the communications with the external actor based on the summary provided from the external actor.

17. The system of claim 16, wherein the processor is further configured to facilitate the communications between the owner of the vehicle and the external actor via the virtual chatbot by providing a virtual chatroom via the remote server when selected by the owner of the vehicle based on the decision of the owner of the vehicle for text communications with the external actor.

18. The system of claim 16, wherein the processor is further configured to facilitate the communications between the owner of the vehicle and the external actor via the virtual chatbot by providing a voice over Internet protocol (VOIP) telephone number via the remote server when selected by the owner of the vehicle based on the decision of the owner of the vehicle for voice communications with the external actor.

19. A vehicle comprising:
a body;
a propulsion system disposed within the body and configured to move the vehicle;
a windshield disposed on the body;
a plurality of microphones configured to obtain microphone sensor data as to a sound made against the windshield;
one or more additional sensors configured to obtain additional sensor data as to a external actor in proximity to the vehicle as the sound is made; and
a processor that is coupled to the plurality of microphones, to the one or more additional sensors, and to a remote server that is remote from the vehicle, the processor configured to at least facilitate:
providing instructions for a notification proximate the vehicle as it is parked, the notification comprising an instruction for an external actor to take an action by knocking on the windshield in order to initiate communications with an owner of the vehicle; and
determining when the action has occurred based on the microphone sensor data, and based on a comparison of the microphone sensor data with a known sound signature for knocking on the windshield that is stored in memory;
determining whether a human is detected in proximity to the vehicle as the action occurs, based on the additional sensor data; and
facilitating the communications between the owner of the vehicle and the external actor upon occurrence of the action occurring and the detecting of the human in proximity to the vehicle as the action occurs, via a virtual chatbot via the remote server that protects contact information of the owner of the vehicle, in accordance with instructions provided by the processor.

20. The vehicle of claim 19, wherein the processor is further configured to at least facilitate:
providing a quick response (QR) code display for the external actor after both the action is detected and the human is detected;
receiving a summary from the external actor as to a circumstance surrounding the vehicle, in response to the QR code display; and
facilitating the communications between the owner of the vehicle and the external actor based on a decision of the owner of the vehicle as to whether to accept the communications with the external actor based on the summary provided from the external actor, including by:
facilitating the communications between the owner of the vehicle and the external actor via the virtual chatbot by providing a virtual chatroom via the remote server when selected by the owner of the vehicle based on the decision of the owner of the vehicle for text communications with the external actor; and
facilitating the communications between the owner of the vehicle and the external actor via the virtual chatbot by providing a voice over Internet protocol (VOIP) telephone number via the remote server when selected by the owner of the vehicle based on the decision of the owner of the vehicle for voice communications with the external actor.
